(19) United States
(12) Patent Application Publication
(10) Pub. No.: US 2015/0041158 A1
(43) Pub. Date: Feb. 12, 2015

(54) FIRE SAFETY CONTROL SYSTEM

(71) Applicants: Brian J. Stumm, Helsinki (FI); Douglas Reardon, Medway, MA (US)

(72) Inventors: Brian J. Stumm, Helsinki (FI); Douglas Reardon, Medway, MA (US)

(73) Assignee: UTC Fire and Security Corporation, Farmington, CT (US)

(21) Appl. No.: 14/009,266

(22) PCT Filed: Dec. 30, 2010
(86) PCT No.: PCT/US10/62548

§ 371 Date: Jun. 13, 2014

(51) Int. Cl. A62C 37/50; A62C 35/02; A62C 37/10

(52) U.S. Cl. CPC A62C 37/50; A62C 37/10; A62C 35/02
USPC 169/43; 169/19

(57) ABSTRACT

A fire safety control system includes a storage container with an agent; a valve on the storage container for releasing the agent; a control head on the valve for actuating the valve; and a connection sensor on the control head for sensing whether the control head is connected to the valve and for producing a connection status signal.

### BACKGROUND

Fire safety systems installed in buildings typically include at least one electric panel that is the controlling component of the fire safety system. The control panel is a hub of the system, it monitors inputs and system integrity, controls outputs and relays information. The panel receives information from environmental sensors that detect environmental changes associated with fire, monitors their operational integrity and provides for automatic control of equipment, which may include release of suppressant, transmission of information necessary to provide notification, and control of a variety of building functions to prepare the facility for fire based on a predetermined sequence.

A typical unit in the system is a storage container which contains firefighting agent under pressure. The storage container is typically a cylinder and generally includes a valve connected to a control head that is connected pneumatically or electrically to the control panel. The control panel can send a signal to the control head to activate the release mechanism, opening the valve and releasing the agent. The agent then passes through an outlet port in the valve to a piping network that distributes the suppressant agent to nozzles placed throughout an installation, for example in a building, where the suppressant is then discharged. The control panel can be programmed to automatically send a signal to the control head to open the valve to release the agent when a detector detects a fire. The valve generally can also be activated manually.

Specific monitoring and checks of the control heads and system in general are required by National Fire Protection Association requirements. This is typically done by physical inspection at the container and involves manually disconnecting the control head to physically inspect it at specific intervals, for example, every six months, then reconnecting the control head. Additionally, agent storage containers must be physically inspected to monitor levels of agent, pressure, temperature, and other conditions as well.

### SUMMARY

According to one embodiment of the present invention, a fire safety system monitors and controls, from a control system, a container assembly. The container assembly includes a storage container containing an agent; a valve on the storage container for releasing the agent; a control head on the valve for actuating the valve; and a connection sensor on the control head to sense the connection between the control head and the valve and for providing a connection status signal to the control system, for example a control panel.

According to one embodiment, a method of monitoring and controlling a fire safety system includes sensing the connection between a control head and a valve on an agent storage container; sending a connection status signal to a control panel containing information indicative of the connection; and controlling the release of agent, in party, by allowing an actuation signal to be sent from the control panel to the control head, causing the control head to open the valve and release the agent if the connection status signal contains information indicative that the control head is properly connected to the valve.

### BRIEF DESCRIPTION OF THE DRAWINGS

FIG. 1 is a block diagram of a fire safety system according to the present invention.

FIG. 2 is a front view of a storage container with an agent under pressure.

FIG. 3 is a cross-sectional view of a control head and valve for a storage container with an agent under pressure.

FIGS. 4A-4C show a close up cross-sectional view of a portion of the control head and valve connection of FIG. 3.

FIG. 5A shows a side view of the upper part of a storage container with a valve, control head and a plurality of sensing devices according to the present invention. FIG. 5B shows a top view of FIG. 5A.

FIG. 6 shows a block diagram an embodiment of the current invention.

### DETAILED DESCRIPTION

The current invention provides a fire safety system for monitoring and controlling a container assembly which releases agent for fighting fires. As the occurrence of fires cannot be predicted, it is essential that fire fighting equipment is always ready to be used. The current invention monitors and controls a container assembly, the container assembly including a storage container containing an agent, a valve (with an outlet port), control head, and a connection sensor for sensing the connection between the control head and the valve on the container and for producing a connection status signal. The connection status signal can be used for example to determine whether the control head is properly installed prior to actuating release of the agent, and/or for providing advance notification of a connection status that is not in a desired state. According to yet other embodiments of the invention, the invention may also include at least one container sensor for sensing a property related to the contents of the container and for providing a sensor signal indicative of that property. The sensor signal can be used for example to provide notification that a property is not in a desired state or within a desired range.

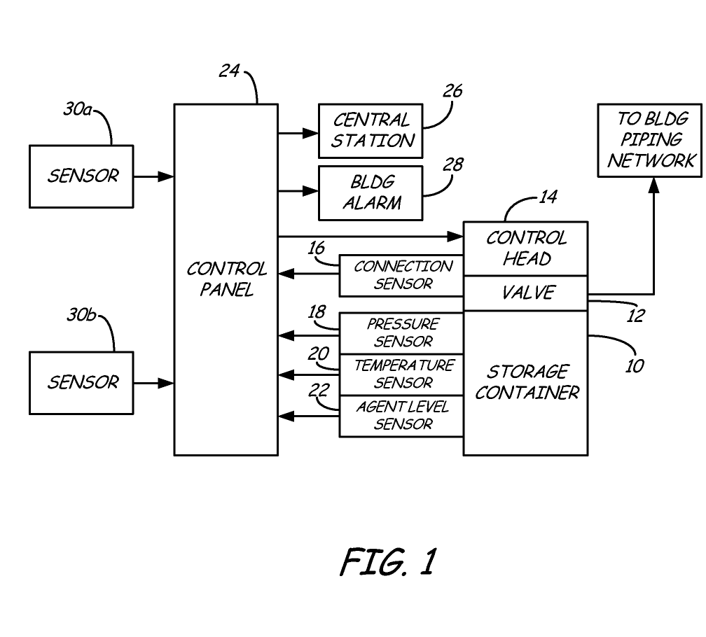

FIG. 1 is a block diagram illustrating one embodiment of a fire safety system according to the present invention, and includes a container assembly including a storage container 10 with an agent under pressure, valve 12 (with outlet port 13), control head 14, connection sensor 16, pressure sensor 18, temperature sensor 20, agent level sensor 22, control panel 24, central station 26, installation alarm system 28, and sensors 30a, 30b. Agent level sensor 22 may, for example, measure the level of liquid suppressant or powder suppressant in container 10.

Sensors 30a, 30b are units placed in various locations within the building being monitored to sense conditions that indicate presence of a hazard condition indicative of a fire, such as smoke, carbon monoxide, and temperature. Sensors 30a, 30b are connected to control panel 24 to send signals to control panel 24 when sensors 30a, 30b sense a hazard contition within the building. Control panel 24 is connected to central station 26 and installation alarm system 28, so that it can send signals to central station 26 and building alarm system 28 when it receives a signal that a hazard condition is sensed within the building. Central station 26 can be a fire station, a central monitoring center, or some other type of outside notification.

Valve 12 is connected to storage container 10 and to the installation piping network. Control head 14 is connected to valve 12 and receives signals from control panel 24. Connection sensor 16 is connected to control head 14 and sends a connection status signal to control panel 24 containing information indicative of the connection between control head 14 and valve 12. Pressure sensor 18, temperature sensor 20 and agent level indicator sensor 22 sense respective properties related to the contents of storage container 10, and send sensor signals to control panel 24 containing information indicative of the status of the properties sensed.

When sensor 30a or 30b detects a hazard condition within an installation, that sensor 30a or 30b sends a signal to control panel 24. Control panel 24 then sends a signal to central station 26 to alert central station 26 to a hazard condition within the building. Control panel 24 also initiates installation alarm 28 to activate the building alarm to alert anyone within the building to the presence of a fire. Additionally, control panel 24 sends a valve actuation signal to control head 14 to actuate valve 12 and outlet port 13, thereby releasing fire fighting agent from storage container 10. Agent then flows through valve 12 into the installation piping network, where the agent will be disbursed through nozzles in locations where the fire was detected.

Connection sensor 16 sends a connection status signal to control panel 24 containing information indicative of the connection between control head 14 and valve 12, for example, indicative of whether control head 14 is properly connected to valve 12. The connection sensor transmission of a signal can be initiated manually, or initiated automatically at certain preset times. The control panel 16 may also request a connection status signal from connection sensor 16, initiated manually or automatically at certain preset times. The certain preset times can be on set calendar days, set periods such as weekly, or can be based upon the occurrence of an event, for example, upon installation, immediately after a fire is detected by sensor 30a or 30b, after discharge from a container, and/or after a storage container 10 has been replaced. Container sensors, for example, pressure sensor 18, temperature sensor 20 and agent level sensor 22 can also send signals to control panel 24 either at certain preset times or based on a manual request.

The fire safety system of the current invention allows for information regarding system readiness to be sent to a control panel from sensors located at the location of storage container 10. This can be used to ensure that the system is properly connected prior to activation, and/or can be used to provide notification that an aspect of the container assembly needs attention. For example, connection sensor 16 provides a connection status signal to the control panel 24 containing information indicative of the status of the connection between the control head 14 and valve 12. This ensures that the system is able to activate and release agent when the system is actuated. Additionally, pressure sensor 18, temperature sensor 20 and agent level sensor 22 allow for measurements of properties related to the contents of the container to be monitored. In one example, the connection status between the control head 14 and valve 12, and sensor status related to a property of the contents of container 10 can be viewed from the control panel, cutting down on the manual work needed for inspection and measurement at individual containers in some instances.

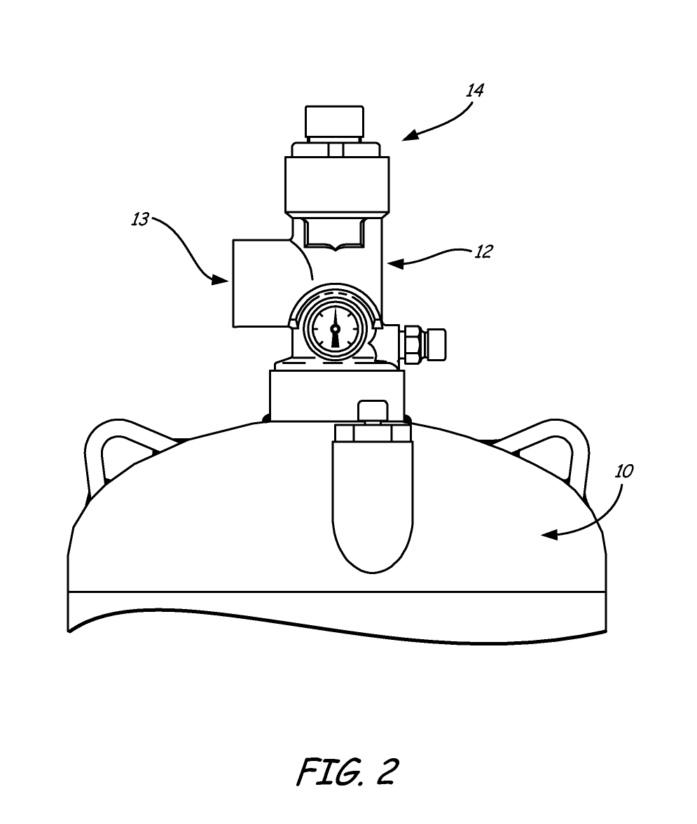

FIG. 2 is a front view of a storage container 10 with an agent under pressure, and includes valve 12 with outlet port 13 and control head 14. Storage container 10 is generally a cylinder made of a fire-resistant material such as aluminum or steel. Container 10 holds an agent under pressure which can be released when a fire is detected. Outlet port 13 is typically connected to a piping network that distributes the agent to nozzles located within an installation, for example a building.

Valve 12 is connected to container 10, typically through a threaded connection. Control head 14 connects to valve 12, and controls valve 12 to contain or release agent under pressure in container 10. When control head 14 controls valve 12 to release agent under pressure from container 10, the agent travels through valve 12 to outlet port 13. Then, the agent travels through the installation's piping network to be released through specifically designed nozzles that disburse the agent into a space where fire was detected.

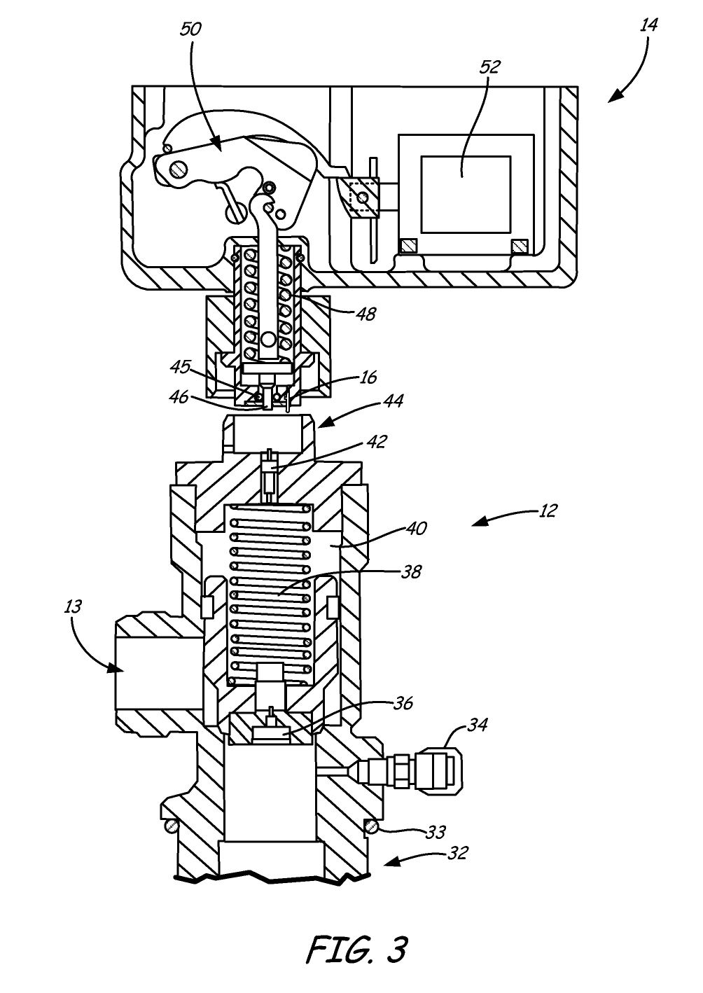

FIG. 3 is a cross-sectional view of a control head 14 and valve 12 for a storage container 10 with an agent under pressure. Valve 12 includes outlet port 13, cylinder connection 32 with 0-ring 33, pressure relief gauge 34, piston 36, spring 38, pressurized area 40, check valve 42, and control top connection 44. Control head 14 includes connection sensor 16, pin 46, spring 48, cam 50 and solenoid 52.

Control head 14 attaches to valve 12 at connection 44. In this example, connection 44 is generally a threaded connection with 0-ring 45 to ensure the connection is properly sealed. When control head 14 is fully seated on valve 12, connection sensor 16 is fully depressed. Valve 12 attaches to container 10 (See FIG. 2) through connection 32, which is typically a threaded connection. Piston 36 is attached to valve spring 38. Spring 38 moves up or down through pressurized area 40. When control head 14 is attached to valve 12, check valve 42 sits a short distance away from pin 46, so that pin 46 can contact check valve 42 when actuated by control head 14. Pin 46 connects to spring 48, which connects to cam 50. Cam 50 can be actuated by solenoid 52 to move spring 48 and thus move pin 46 up or down. Control head 14 is controlled remotely by signals from control panel 24 (see FIG. 1). The control panel can either command control head 14 to open valve 12 in response to a manual input (for example, by pressing a button on the control panel) or it can automatically command control head 14 to open valve 12 in response to a hazard condition having been sensed.

Piston 36 is moved up or down by spring 38 to open or block outlet port 13, thereby controlling whether agent can travel from container 10 to outlet port 13 (and then to various locations within a building). The natural state of spring 38 is to hold piston 36 at a level where valve 12 is open, and agent can freely travel from agent storage container 10 to outlet port 13. However, piston 36 can be pushed downward, stretching out spring 38, by check valve 42 increasing pressure in pressurized area 40. If check valve 42 then decreases pressure in pressurized area 40, spring 38 will move back towards its natural state, moving piston 36 upwards, and therefore allowing agent to flow from container 10 to outlet port 13. If pressure in pressurized area 40 is at a level where piston is pushed downward and spring 38 is stretched, piston 36 blocks agent in container 10 from flowing to outlet port 13. Check valve 42 is made to increase or decrease pressure (therefore causing valve 12 to open or close) by control head 14, and specifically by pin 46 which can press down on check valve 42 to let pressure out of pressurized area 40. Pin 46 is controlled through the activation of solenoid 52. Solenoid 52 could be activated remotely, from control panel 24 or other device. The activation of solenoid 52 causes cam 50 to rotate to move spring 48, which then moves pin 46.

Control head 14 allows valve 12 to be remotely activated by control panel 24, allowing agent to travel from storage container 10 to outlet port 13 and then to an area with a fire. For the system to work properly, control head 14 must be fully seated on valve 12 so that the movement of pin 46 controls check valve 42 and therefore controls the movement of piston 36. In a typical system, control head 14 is removed and inspected at set intervals throughout the year, for example, every six months.

The current system incorporates connection sensor 16 for sensing the connection between control head 14 and valve 12. In cases where control head 14 is not fully seated on valve 12, this state is revealed by connection sensor 16, and the connection status signal is sent to control panel 24. The connection status signal can be used by control panel 24 to monitor whether control head 14 is able to control valve 12 to open valve 12 and release agent, and can readily provide automated notification when the connection needs attention.

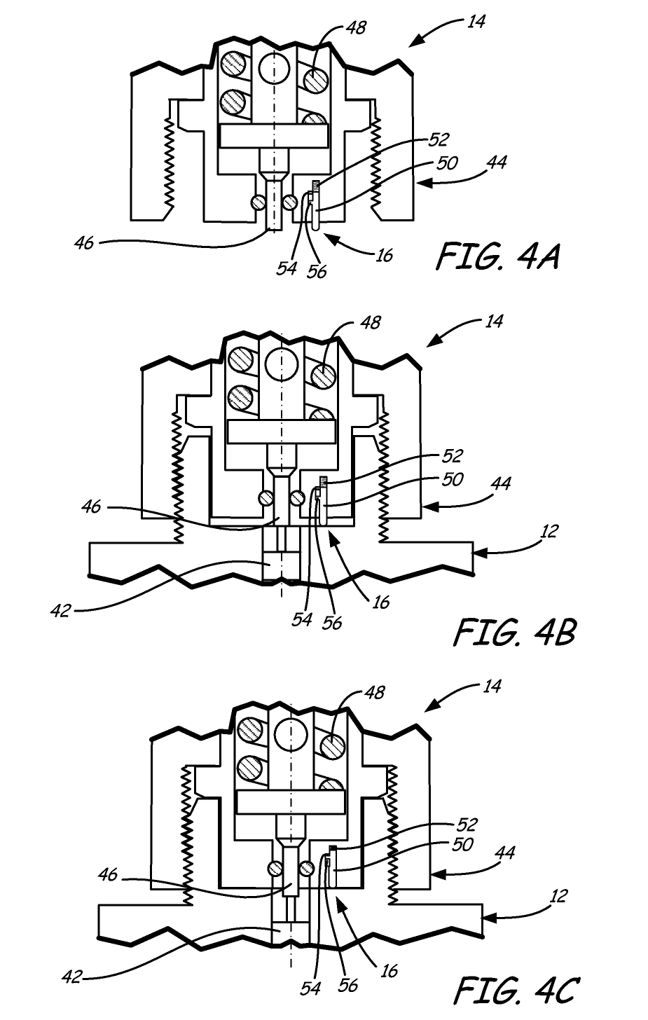

FIGS. 4A-4C show close up cross-sectional views of a portion of the control head and valve connection of FIG. 3. FIG. 4A shows the control head and valve not connected. FIG. 4B shows the control head and valve partially connected. FIG. 4C shows the control head and valve fully connected. FIGS. 4A-4C include control head 14 with connection sensor 16 and pin 46. FIGS. 4B-4C include valve 12 with check valve 42. Connection sensor 16 is a plunger switch, and includes pin 50, spring 52, switch 54, and cavity 56.

Connection sensor 16 is set in control head 14. Spring 48 is connected to control head 14 and to pin 46. Switch 54 is located at an upper position of cavity 56 in control head 14. Pin 50 can move up to sit almost completely within control head 14 or can extend out of control head 14.

As seen in FIG. 4A, when control head 14 is not attached to valve 12, pin 50 of connection sensor 16 extends out of control head 14, and spring 52 rests in its natural state. As control head 14 attaches to valve 12 through threaded connection 44, pin 50 of connection sensor 16 is pushed into control head 14, compressing spring 52 and causing pin 50 to actuate switch 54 located in the upper end of cavity 56 (FIGS. 4B-4C). The actuation of switch 54 sends a signal to a control panel that control head 14 is fully seated on valve 12 in the desired position. If switch 54 is not actuated when control head 14 is set on valve 12, no signal is sent. In this example, the absence of a signal would be recognized by the control panel to indicate that control head 14 not being properly installed on valve 12. Alternatively, a signal could be sent to the control panel affirmatively alerting it to the problem when it is sensed that control head 14 is not properly on valve 12. Switch 54 can be a mechanical, optical or magnetic switch depending on system requirements.

While FIGS. 4A-4C show connection sensor 16 as a part of control head 14, connection sensor 16 could be placed in valve 12, in an insert between valve 12 and control head 14, or in any other suitable location where it would be able to sense whether control head 12 is properly connected to valve 12.

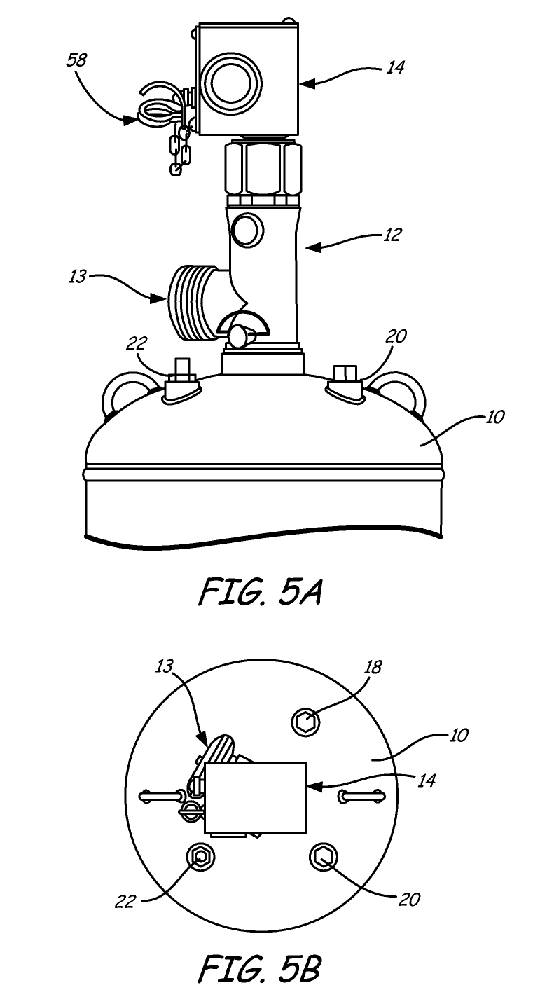

FIG. 5A shows a side view of the upper part of a storage container 10 with a valve 12, control head 14 and a plurality of container sensing devices 18, 20, 22 for sensing a property related to the content of the container. FIG. 5B shows a top view of FIG. 5A. FIGS. 5A-5B include storage container 10 with an agent under pressure, and includes valve 12 with outlet port 13, control head 14 (with manual pin 58 and connection sensor (not shown)), pressure sensor 18, temperature sensor 20, and liquid level sensor 22.

Control head 14 is attached to valve 12. In this example, control head 14 includes manual pin 48, which, if pulled, will cause control head 14 to open valve 12. Outlet port 13 extends from valve 12. Valve 12 connects to container 10. Agent level indicator device 22, pressure sensor 18, and temperature sensor 20 connect to container 10 for producing sensor signals that can be used by the control system, for example a control panel.

As discussed in relation to FIGS. 3 and 4A-4C, connection sensor 16 detects whether control head 14 is properly on valve 12, and sends a connection status signal to the control panel containing information indicative of the connection between the control head 14 and the valve 12. Pressure sensor 18 senses the pressure in container 10, and temperature sensor 20 senses the temperature of the agent in container 10. Liquid level sensor 22 determines the level of liquid in container 10. Each of liquid pressure sensor 18, temperature sensor 20, and liquid level sensor 22, can produce signals containing information indicative of the respective property related to the content of the container that can be used by the control system. Additionally, control panel 24 could initiate a notification if any of the signals from sensors 18, 20, 22 indicated properties that were outside of a predefined range. In one example, this is only done if sensors 18, 20, 22 detect a predefined protocol language in the system. If the predefined protocol language is not recognized in the system to which they are hooked up, only information on whether control head 14 is properly connected to valve 12 will be reported to control panel 24.

In past systems, persons would have to go to container 10 to read gauges, thermometers or other devices to find the measurement of properties of container 10 and/or the agent within container 10. With the current invention, this information can be relayed directly to control panel 24, saving the manpower required to go to the devices on container 10 and read them. This is especially useful in systems that have a large number of containers, or in systems where the containers are in an area not easily accessible. Container sensors 18, 20, 22 can be utilized for real time measurements of properties related to contents of container 10 that can be communicated through bidirectional communication with control panel 24. This can be used to monitor the contents of container 10 to ensure that the contents are being stored in proper conditions, that sufficient agent is in container 10, whether container 10 has actually discharged, etc. Monitoring the properties related to the contents of container 10 can provide information useful for planning service of container 10, for example when it will need to be refilled or replaced. Having this information available at control panel 24 can save time and manpower that would be needed to physically go to container 10 and check it. It also ensures that any undesired conditions, such as a leak in the container, would be known more readily.

Additionally, the data from container sensors 18, 20, 22 could be collected at certain preset times and sent to customers or owners of the fire fighting system. This would inform customers or owners more quickly of any irregularities, as well as allow them to remotely inspect the status of the containers with agent within the system where appropriate. This could be done automatically or manually with a command from control panel 24.

While container sensors 18, 20, 22 are indicated to detect pressure, temperature and liquid level in container 10, other sensors detecting other properties could be used. Additional sensors could sense weight, evidence of tampering, or any other properties desired, and produce signals containing information indicative of the status of that property so that it is available to the control system, for example control panel 24. In one embodiment, the signals are produced to the control system if a predefined protocol language was detected. In an alternative embodiment all sensors could send information detected regardless of protocol language used in the system.

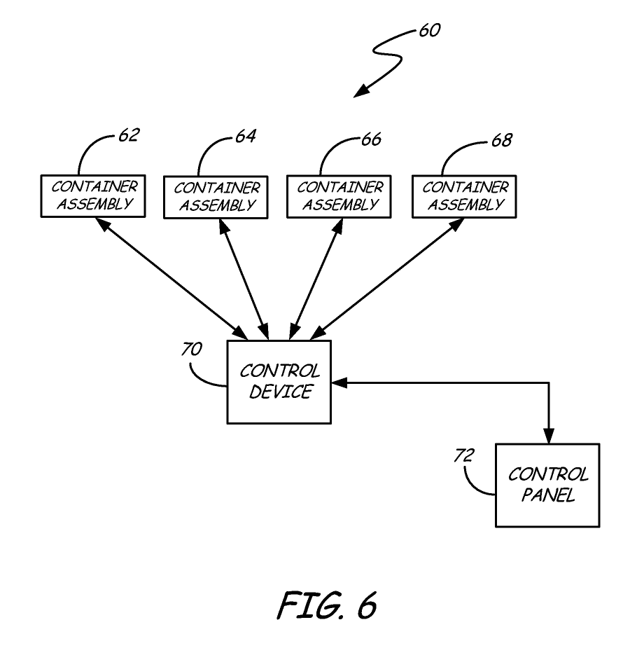

FIG. 6 shows a block diagram of an embodiment of the current invention with a control system additionally including a local control device 70 near a bank of storage containers. FIG. 6 includes bank 60 of a plurality of agent storage container assemblies 62, 64, 66, 68, control device 70 and control panel 72. Each agent storage container assembly 62, 64, 66, 68 includes a valve, a control head and a connection sensor as shown in FIGS. 2-4C. Additionally, each storage container assembly 62, 64, 66, 68 can include additional sensors as shown in FIGS. 5A-5B. Generally control device 70 is wired to control panel 72, but can be wireless. Individual agent storage container assemblies 62, 64, 66, 68 can be wired to control device 70 or can connected wirelessly, for example, through a radio frequency transmitter and receiver. While four agent storage containers are shown in bank 60, more or less storage containers could form bank 60 and each storage container would communicate with control device 70.

Connection sensors on each of agent storage container assembly 62, 64, 66, 68 sense the connection between the control head and the valve within each individual container assembly 62, 64, 66, 68 for producing a connection status signal indicative of the status of the connection, for communicating that information to local control device 70. Local control device 70 can communicate that information to control panel 72. Communication is bi-directional, and control panel 72 can send to control device 70 commands and/or inquiries regarding bank 60 of storage containers, or regarding individual storage container assemblies 62, 64, 66, 68. If storage container assemblies 62, 64, 66, 68 have additional sensors as discussed in relation to FIGS. 5A-5B. According to one embodiment, if a protocol language is detected, control device 70 can communicate with control panel 72 regarding additional properties sensed. These communications can be done through wires, or can be wireless.

By connecting individual storage container assemblies 62, 64, 66, 68 in bank 60 to control device 70, and then having control device 70 communicate with control panel 72, this embodiment of current invention can use less wiring and coordinate communication to and from control panel 72. Connecting each storage container assembly 62, 64, 66, 68 to control device 70 located near bank 60, and then connecting only control device 70 to control panel 72 uses less wiring in systems than if each container 62, 64, 66, 68 were individually wired to and communicating with control panel 72. Less wiring would be particularly desirable for installation of large systems as well.

While the invention has been discussed in relation to using a plunger switch as connection sensor 16 to sense whether control head 14 is properly connected to valve 12, any number of mechanical, electrical, magnetic, or optical sensors could be used to sense the connection between control head 14 and valve 12 and can be used to send a connection status signal to the control panel, including a normally open/normally closed switch, a magnetic switch, a pressure switch or an optical switch.

While the invention has been discussed in relation to releasing an agent under pressure, some firefighting agents are not under pressure in storage containers. The current invention could also apply to systems using agents not under pressure or systems which store agent not under pressure and then pressurize when called to action to release agent.

The disclosed examples include various relationships and features for sensing the connection of a control head and valve and for using the sensed information. The disclosed examples include various relationships and features for sensing properties related the contents of the container and for using the sensed information. Some examples do not include all of the features but only a selected one or a selected combination of less than all of them. Any one of the discussed features may be used in combination with any others of them.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims

1. A fire safety control system, the system comprising:
a storage container with an agent;
a valve on the storage container for releasing the agent;
a control head on the valve for actuating the valve; and
a connection sensor on the control head for sensing whether the control head is connected to the valve and for producing a connection status signal.

2. The system of claim 1, wherein the connection sensor is capable of producing a connection status signal that contains information indicative that the control head is properly connected to the valve.

3. The system of claim 1, wherein the connection sensor is capable of producing a connection status that contains information indicative that the control head is not properly connected to the valve.

4. The system of claim 1, wherein the control head is capable of communicating with a control panel.

5. The system of claim 1, wherein the connection sensor includes a plunger switch.

6. The system of claim 2, wherein the connection sensor produces a connection status signal when the control head is fully seated on the valve.

7. The system of claim 1, and further comprising:
a container sensor for sensing a property relating to the contents of the container and for providing a sensor signal containing information indicative of the property.

8. The system of claim 7, wherein the container sensor is for sensing pressure in the container and for providing a sensor signal containing information indicative of the pressure in the container.

9. The system of claim 7, wherein the container sensor is for sensing agent level in the container and for providing a sensor signal containing information indicative of the agent level in the container.

10. The system of claim 7, wherein the container sensor is for sensing weight of the container and for providing a sensor signal containing information indicative of the weight of the container and contents.

11. The system of claim 7, wherein the container sensor is for sensing temperature of contents of the container and for providing a sensor signal containing information indicative of the temperature of the contents.

12. The system of claim 8, wherein the container sensor recognizes a predefined protocol language being used by the system and transmits a container sensor signal when it recognizes the predefined protocol language.

13. The system of claim 1, and further comprising:
a control system in communication with the connection sensor for receiving the connection sensor signal and for providing notification of the status of the connection.

14. The system of claim 1, and further comprising:
a control system in communication with the connection sensor for receiving the connection status signal and for controlling the release of agent based in part upon status of the connection.

15. A method of monitoring and controlling a fire safety system, the method comprising:
sensing the connection between a control head and a valve on an agent storage container; and
sending a connection status signal containing information indicative of the connection between the control head and valve.

16. The method of claim 15, and further comprising:
receiving the connection status signal at a control system and controlling the release of agent by not allowing an actuation signal to be sent from the control system to the control head if the control head is not connected to the valve in the desired manner

17. The method of claim 16, and further comprising:
providing notification from the control system if the connection status signal contains information indicative that the control head is not connected to the valve in the desired manner

18. The method of claim 15, and further comprising:
sensing a property related to the contents of the container and producing a signal indicative of the property.

19. The method of claim 18, and further comprising:
sending the signal indicative of the property to the control system.

20. The method of claim 18, and further comprising:
sensing whether a predefined protocol language is being used by the control system; and
sending the signal indicative of the property to the control system if the predefined protocol language is being used by the system.

21. The method of claim 20, and further comprising:
monitoring signals sent to the control system regarding the property; and
initiating a notification if the signal contains information indicative that the property monitored is not in a desired state.

22. A fire fighting safety system comprising:
a plurality of storage containers, each container with an agent;
a valve on each storage container for releasing agent from that container;
a control head on each valve for actuating the valve;
a control device located near the plurality of storage containers and connected to each storage container for monitoring the storage containers;
a control panel electrically connected to the control device for monitoring and controlling the system and for communicating with the control device regarding one or more storage containers; and
a connection sensor on each control head to sense the connection of that control head to that valve on each container and to send a connection status signal to the control device containing information indicative of the connection between the control head and the valve.

23. The system of claim 22, and further comprising:
one or more container sensors on each of the containers to sense properties related to the content of that container.

24. The system of claim 23, including at least one container sensor for sensing pressure in at least one container and for providing a sensor signal containing information indicative of the pressure in the container.

25. The system of claim 23, including at least one container sensor for sensing agent level in at least one container and for providing a sensor signal containing information indicative of the agent level within the container.

26. The system of claim 23, including at least one container sensor for sensing the weight of at least one container and its contents and for providing a sensor signal containing information indicative of the weight of the container and contents.

27. The system of claim 23, wherein the control device communicates with the control panel regarding the properties sensed only if a predefined protocol language is in use in the system.
